(19) United States
(12) Patent Application Publication
(10) Pub. No.: US 2017/0337548 A1
(43) Pub. Date: Nov. 23, 2017

(54) Card Processing Methods and Systems

(71) Applicant: Rev Worldwide, Inc., Austin, TX (US)

(72) Inventors: Daryn GRIGGS, Moolaba (AU); Futeh KAO, Austin, TX (US); Andrew TAYLOR, Onehunga (NZ); Simon HILTON, Kohimarama (NZ)

(21) Appl. No.: 15/525,583

(22) PCT Filed: Nov. 10, 2015
(86) PCT No.: PCT/NZ2015/050187

§ 371 Date: May 9, 2017

(30) Foreign Application Priority Data
Nov. 10, 2014 (NZ) 701814

(51) Int. Cl. G06Q 20/36; G06Q 20/22; G06Q 20/34; G06Q 20/38

(52) U.S. Cl. CPC G06Q 20/36; G06Q 20/381; G06Q 20/227; G06Q 20/3572

(57) ABSTRACT

Example card processing methods and systems are described. The card processing system may receive a request to approve or reject a transaction using a multicurrency card with multiple account balances in multiple currencies. The transaction may be associated with a transaction amount in a transaction currency. In response to determination that the first account balance is not available or insufficient to fund the transaction amount, the card processing system may determine, from the multiple account balances, a second account balance in a second currency that is different to the transaction account to fund the transaction amount. An exchange rate may be selected for dynamic currency conversion of part or all of the second account balance from the second currency to the transaction currency; and a determination made as to whether to approve or reject the transaction based on the dynamic currency conversion using the selected exchange rate.

### TECHNICAL FIELD

The present disclosure relates to card processing methods and systems.

### BACKGROUND

Transactions using payment cards such as debit cards and credit cards have become ubiquitous. Most merchants accept payment cards for transactions with consumers, such as the purchase of goods and services. Payment networks are designed to process data associated with payment cards during transactions between merchants and cardholders. Some payment cards allow a consumer to conduct transactions in a foreign currency that is different to the local currency of the country the cards are issued in, such as when the cardholder is overseas or making a purchase from a foreign merchant.

### SUMMARY OF THE DISCLOSURE

According to a first aspect, there is provided a card processing method implemented by a card processing system, comprising:

receiving a request to approve or reject a transaction using a multicurrency card with multiple account balances in multiple currencies, wherein the transaction is associated with a transaction amount in a transaction currency;

determining, from the multiple account balances, a first account balance in a first currency that is the same as the transaction currency to fund the transaction amount;

in response to determination that the first account balance is not available or insufficient to fund the transaction amount,
determining, from the multiple account balances, a second account balance in a second currency that is different to the transaction account to fund the transaction amount;
selecting an exchange rate for dynamic currency conversion of part or all of the second account balance from the second currency to the transaction currency; and
determining whether to approve or reject the transaction based on the dynamic currency conversion using the selected exchange rate.

To select the exchange rate, multiple candidate exchange rates may be retrieved, in real time, from multiple foreign exchange (FX) provider systems to convert the second currency to the transaction currency. The exchange rate from the multiple candidate exchange rates that is the most favourable for the dynamic currency conversion may then be selected. For example, the selected exchange rate may be an effective exchange rate determined based on a fee associated with the dynamic currency conversion.

The card processing system may comprise at least one of: an interface to receive, from a card issuer system or a merchant system, the request to approve or reject the transaction; an FX evaluator to determine the first account balance and the second account balance to fund the transaction amount; and an FX engine to retrieve the exchange rate from an FX provider system.

The FX engine may implement an abstraction layer at the card processing system to communicate with multiple FX provider systems using multiple communication protocols and to retrieve multiple candidate exchange rates from which the exchange rate is selected.

To determine the second account balance in the second currency, a rule associated with the dynamic currency conversion of the second account balance may be retrieved. In this case, the second account balance may be selected from the multiple account balances based on the rule. For example, the retrieved rule may define an order according to which dynamic currency conversion is iteratively performed on the multiple account balances until the transaction amount is fully funded.

In one example, determining whether to approve or reject the transaction may be performed as follows. In response to determination that dynamic currency conversion of part or all of the second account balance is insufficient to fund the transaction amount, at least one further second account balance in a further second currency may be determined to fund the transaction amount. In this case, a further exchange rate may be retrieved for dynamic currency conversion of the further second currency to the transaction currency to fund a remaining transaction amount.

Determining to approve or reject the transaction may further be performed as follows. In response to determination that the first account balance is available but insufficient to fund the transaction amount, a sum of the first account balance and the second account balance in the transaction currency after dynamic currency conversion may be determined. If the sum is sufficient to fund the transaction amount, the transaction is approved.

Prior to the transaction, a request to transfer an amount from a source account balance in a source currency to a destination account balance in a destination currency may be received. In this case, an exchange rate for currency conversion from the source currency to the destination currency may be retrieved. The source account balance and destination account balance may then be updated based on the amount to be transferred and the exchange rate.

The multicurrency card may be a debit card, credit card or prepaid card with a card number associated with the multiple account balances in multiple currencies.

According to a second aspect, there is provided a computer system capable of acting as a card processing system to perform a card processing method according to the first aspect. For example, the computer system may comprise a processor; and a non-transitory computer-readable medium having stored thereon instructions that, when executed by the processor, cause the processor to:

receive a request to approve or reject a transaction using a multicurrency card with multiple account balances in multiple currencies, wherein the transaction is associated with a transaction amount in a transaction currency;

determine, from the multiple account balances, a first account balance in a first currency that is the same as the transaction currency to fund the transaction amount;

in response to determination that the first account balance is not available or insufficient to fund the transaction amount,
determine, from the multiple account balances, a second account balance in a second currency that is different to the transaction account to fund the transaction amount;
select an exchange rate for dynamic currency conversion of part or all of the second account balance from the second currency to the transaction currency; and
determine whether to approve or reject the transaction based on the dynamic currency conversion using the selected exchange rate.

According to a third aspect, there is provided a non-transitory computer-readable storage medium that includes a set of instructions which, in response to execution by a processor of a card processing system, causes the processor to perform a card processing method according to the first aspect.

According to a fourth aspect, there is provided a card processing method implemented by a card processing system, comprising

receiving a request to approve or reject a transaction using a multicurrency card with multiple account balances in multiple currencies, wherein the multicurrency card is a debit or credit card, and the transaction is associated with a transaction amount in a transaction currency;

determining, from the multiple account balances, a first account balance in a first currency that is the same as the transaction currency to fund the transaction amount;

in response to determination that the first account balance is not available or insufficient to fund the transaction amount,
determining, from the multiple account balances, a second account balance in a second currency that is different to the transaction currency to fund the transaction amount;
retrieving an exchange rate for currency conversion of part or all of the second account balance from the second currency to the transaction currency, wherein the exchange rate is retrieved from one or more foreign exchange provider systems either in real time or prior to receiving the request; and
determining whether to approve or reject the transaction based on the currency conversion using the exchange rate.

According to a fifth aspect, there is provided a computer system capable of acting as a card processing system, wherein the computer system comprises:

a processor; and a non-transitory computer-readable medium having stored thereon instructions that, when executed by the processor, cause the processor to:

receive a request to approve or reject a transaction using a multicurrency card with multiple account balances in multiple currencies, wherein the multicurrency card is a debit or credit card, and the transaction is associated with a transaction amount in a transaction currency;

determine, from the multiple account balances, a first account balance in a first currency that is the same as the transaction currency to fund the transaction amount;

in response to determination that the first account balance is not available or insufficient to fund the transaction amount,
determine, from the multiple account balances, a second account balance in a second currency to fund the transaction amount, wherein the second currency is different to the transaction currency;
retrieve an exchange rate for currency conversion of part or all of the second account balance from the second currency to the transaction currency, wherein the exchange rate is retrieved from one or more foreign exchange provider systems either in real time or prior to receiving the request; and
determine whether to approve or reject the transaction based on the currency conversion using the exchange rate.

According to a fifth aspect, there is provided a card processing method implemented by a merchant system or card issuer system, comprising: sending, to a card processing system according to the second or fourth aspect, a request to approve or reject a transaction using a multicurrency card with multiple account balances in multiple currencies; and receiving, from the card processing system, a determination as to whether to approve or reject the transaction based on a dynamic currency conversion of part or all of a second account balance determined from the multiple account balances.

According to a further aspect, there is provided a merchant system or card issuer system to implement the card processing method according to the fifth aspect. According to yet a further aspect, there is provided a non-transitory computer-readable storage medium that includes a set of instructions which, in response to execution by a processor of a merchant system or card issuer system, causes the processor to perform a card processing method according to the fifth aspect.

### BRIEF DESCRIPTION OF DRAWINGS

FIG. 1 is a schematic diagram of an example payment network in which card processing may be implemented;

FIG. 2 is a schematic diagram of an example multicurrency card with multiple account balances in multiple currencies;

FIG. 3A to FIG. 3F are example user interfaces for transferring funds to a multicurrency card;

FIG. 4 is a flowchart of an example process for transferring funds to a multicurrency card;

FIG. 5 is a flowchart of an example process for determining whether to approve or reject a transaction using a multicurrency card;

FIG. 6A and FIG. 6B are schematic diagrams of example transactions using a multicurrency card;

FIG. 7 is a flowchart of an example iterative process for determining multiple second account balances to fund a transaction;

FIG. 8 is a flowchart of an example process for communicating with a merchant system and a card issuer system;

FIG. 9 is a schematic diagram of an example class diagram that represents a high level implementation of a multicurrency platform based on an object-oriented programming framework;

FIG. 10 is a schematic diagram of example function calls using example classes in FIG. 9; and

FIG. 11 is a schematic diagram of an example computer system capable of acting as a card processing system.

### DETAILED DESCRIPTION

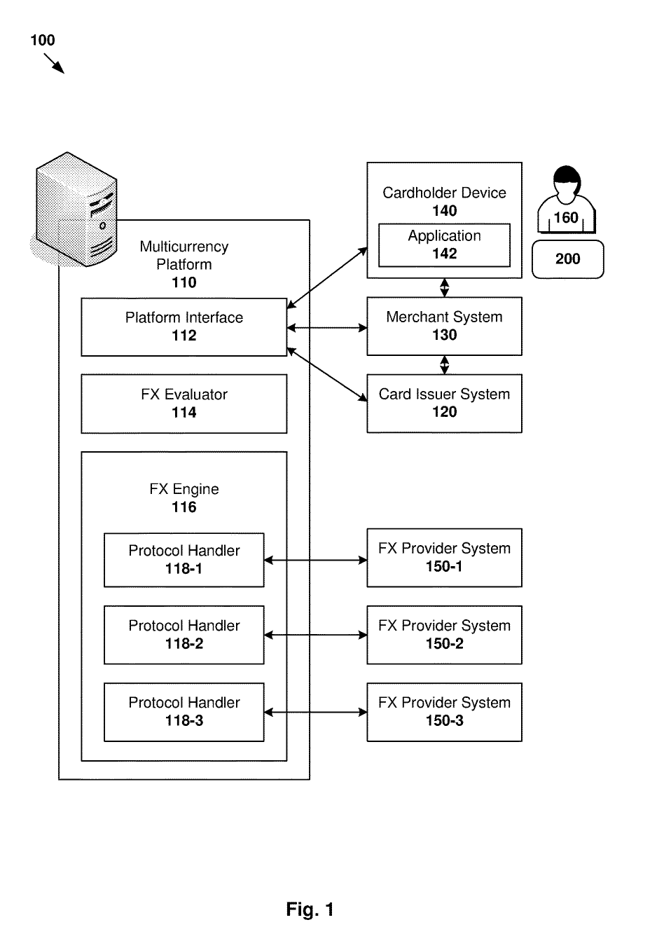

FIG. 1 is a schematic diagram of an example payment network 100 in which card processing may be performed. Payment network 100 may include a network of suitable processing entities (e.g., computer systems, devices, servers, etc.) with the ability to initiate, route or process a transaction. In the example in FIG. 1, payment network 100 includes example card processing system 110 (referred to as “multicurrency platform”) that communicates with multiple card issuer systems 120, merchant systems 130, and cardholder devices 140 (one shown for simplicity), as well as FX provider systems 150-1 to 150-3.

Card issuer system 120 is associated with a card issuer (e.g., bank, credit institution, payments processor, etc.) that issues cardholder 160 with multicurrency card 200 for transactions with merchant system 130, such as the purchase of goods and services using a transaction amount in a transaction currency. Merchant system 130 may include any suitable device or devices enabled to facilitate the transaction.

For example, merchant system 130 may include a point of sale (POS) terminal with a card reader to obtain information of multicurrency card 200. The merchant system 130 may also include a server to interact with cardholder device 140 during a transaction. In the case of online purchases, information of multicurrency card 200 may be provided by cardholder device 140 to the server of merchant system 130, such as via software application 142 (or “App”) installed on cardholder device 140. Any suitable cardholder device 140 may be used, such as a smartphone, tablet computer, desktop computer, wearable computer (e.g., smart watch), etc.

FX provider systems 150-1 to 150-3 are each associated with an FX provider, which sells and buys currencies at FX rates retrievable by multicurrency platform 110 either in real time or at predetermined intervals (e.g., every four hours, daily, etc.). FX provider systems 150-1 to 150-3 will also be collectively referred to as “FX provider systems 150” or individually as a general “FX provider system.” Although not shown, communications among various systems in payment network 100 may be implemented using any suitable networks, such as the Internet, wireless networks, virtual private network, etc.

Multicurrency platform 110 may be implemented using hardware, software or a combination of both. In the example in FIG. 1, multicurrency platform 110 includes platform interface 112, FX evaluator 114 and FX engine 116. Platform interface 112 serves as a gateway for card issuer system 120, merchant system 130 and cardholder device 140 to communicate with multicurrency platform 110 and access its data processing functions. FX engine 116 is to communicate with FX provider systems 150-1 to 150-3 to retrieve FX rates required for currency conversions. FX evaluator 114 is to perform data processing relating to comparison of retrieved FX rates, for example to dynamically select an FX rate for a particular conversion.

In practice, different FX provider systems 150-1 to 150-3 may utilise different communication protocols. To facilitate communication with different FX provider systems 150-1 to 150-3, FX engine 116 may include protocol handlers 118-1 to 118-3 to each implement a different communication protocol. As such, FX Engine 116 supports an “abstraction layer” that isolates a specific implementation of an FX provider from the rest of multicurrency platform 110 (e.g., platform interface 112 and FX evaluator 114). Protocol handlers 118-1 to 118-3 will also be referred to as “protocol handlers 118” or “protocol 118.” Any suitable protocols may be implemented, such as FIX protocol, web service(s), proprietary interface, etc.

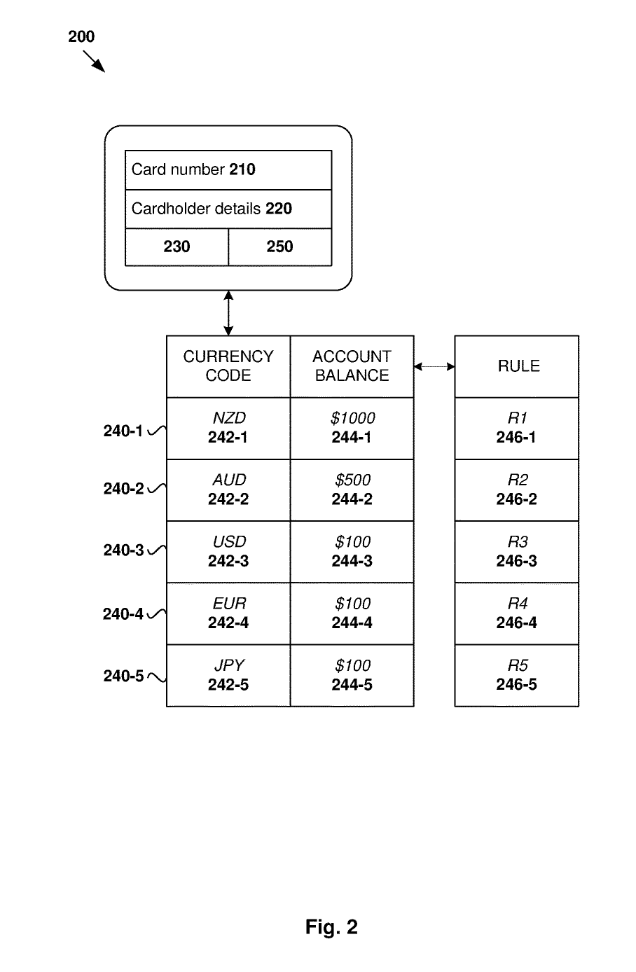

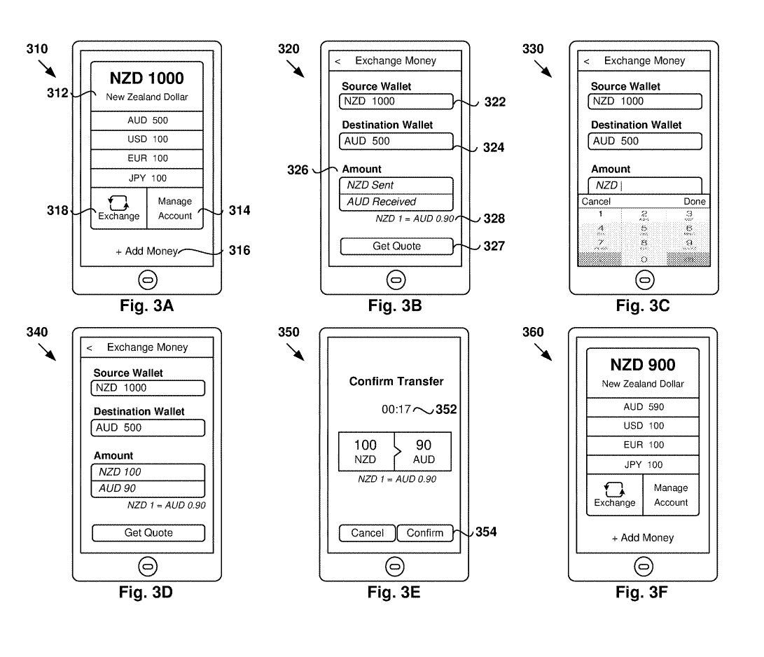

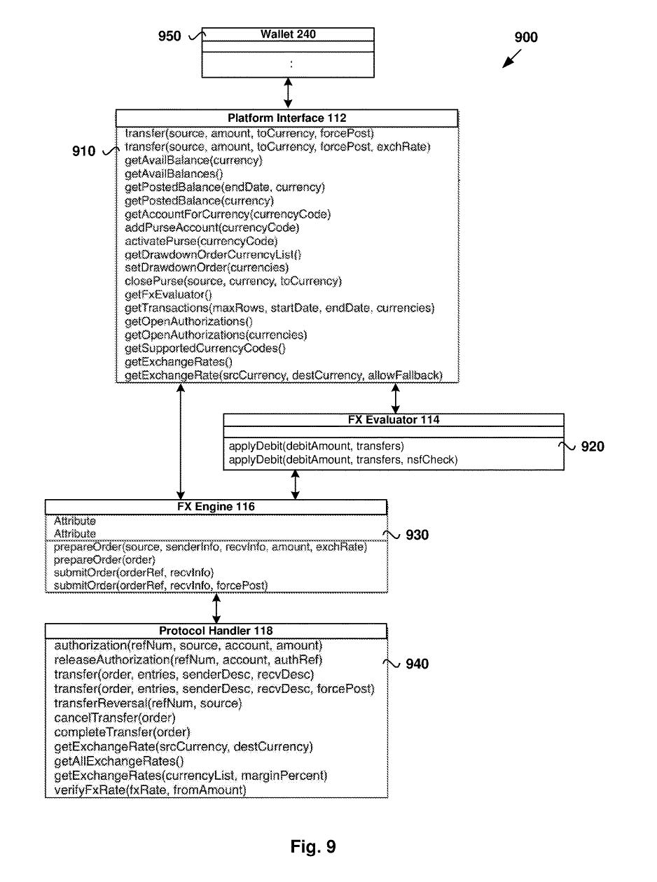

In the rest of the present disclosure, example multicurrency card 200 will be explained in further detail using FIG. 2, example processes performed by multicurrency platform 110 using FIG. 3 to FIG. 8, and example implementations of multicurrency platform 110 using FIG. 9 to FIG. 11.

Multicurrency Card

FIG. 2 is a schematic diagram of an example multicurrency card 200 that may be used for a transaction facilitated by example payment network 100 in FIG. 1. Multicurrency card 200 may include any suitable card information, such as card number 210, details 220 (e.g., name) of cardholder 160, card issuer information (e.g., brand, etc.) and/or type of card 230, etc. Card number 210 may be in any suitable format, such as a six-digit Issuer Identification Number (IIN) or Bank Identification Number (BIN), followed by an account identifier and a check digit, etc. Although not shown, multicurrency card 200 may display or be associated with other types of card information, such as expiration date, security code information, etc.

Multicurrency card 200 may be a debit card, credit card or prepaid card issued by a card issuer. Unlike a prepaid card, a debit card is generally linked to a bank account in the “local currency” of the country in which the card is issued, such as New Zealand Dollar (NZD) when the issuing country is New Zealand. In the case of credit card, a credit line is generally extended to cardholder 160 in the local currency (e.g., NZD). The local currency is also known as the primary currency or default currency.

According to examples in the present disclosure, multicurrency card 200 supports transactions in both local and foreign currencies. In the example in FIG. 2, multicurrency card 200 is linked to multiple wallets (see 240-1 to 240-5) with account balances (see 244-1 to 244-5) in multiple currencies (see 242-1 to 242-5). Data relating to multicurrency card 200 and wallets 240-1 to 240-5 may be stored on a local or remote data store (not shown for simplicity) accessible by multicurrency platform 110. Wallets 240-1 to 240-5 will be collectively referred to as “wallets 240” or individually as a general “wallet 240”. Account balances 244-1 to 244-5 will be referred to as “account balances 244” or “account balance 244”, and currencies 242-1 to 242-5 as “currencies 242” or “currency 242”.

The term “wallet” is used generally to represent an account with an account balance in a particular currency. For example, wallet 240-1 is associated with a local currency 242-1 (e.g., NZD) with account balance 244-1 (e.g., $1000). There may be any suitable number of foreign currency wallets, such as wallets in Australian Dollar (AUD) 242-2, United States Dollar (USD) 242-3, Euro (EUR) 242-4 and Japanese Yen (JPY) 242-5. The corresponding account balances 244-2 to 244-5 are AUD500, USD100, EUR100 and JPY100, respectively. Although some examples are shown in FIG. 2, it will be appreciated that there may be alternative or additional wallets in any suitable currency.

Further, wallets 240-1 to 240-5 may be associated with rules 246-1 to 246-5 relating to how dynamic currency conversion may be performed on account balances 244-1 to 244-5 to fund a transaction in a transaction currency. Dynamic currency conversion to the transaction currency may be required for various reasons, such as insufficient account balance in that transaction currency or none of wallets 240-1 to 240-5 are in the transaction currency. Rules 246-1 to 246-5 may be stored on a storage device accessible by multicurrency platform 110.

For example, rules 246-1 to 246-5 (represented using “R1” to “R5”) may define an order according to which dynamic currency conversion may be iteratively performed using account balances 244-1 to 244-5 to convert them to the transaction currency. The order may also be known as a “draw down order”. Each rule (e.g., “R1” 246-1) may be applied on a particular account balance 244, or a number of account balances 244. Rules 246-1 to 246-5 (“rules 246” or “rule 246”) will be further explained with reference to FIGS. 3, 6A-6B, 7 and 8.

Multicurrency card 200 may be a physical card whose information may be obtained by a card reader of merchant system 130, such as a magnetic strip card, chip card, smart card, etc. In some examples, multicurrency card 200 may include storage 250 to store information relating to card number 210, cardholder details 220, currencies 242, account balances 244, etc. A card reader may be a smart card reader, magnetic strip reader, a bar code reader, a radio frequency reader, a near field communication (NFC) reader or any other reader capable of obtaining information from multicurrency card 200. Alternatively or additionally, multicurrency card 200 may be used as a “virtual card”, which refers generally to an electronic, non-physical representation of a card.

Funds Transfer Between Wallets Prior to Transactions

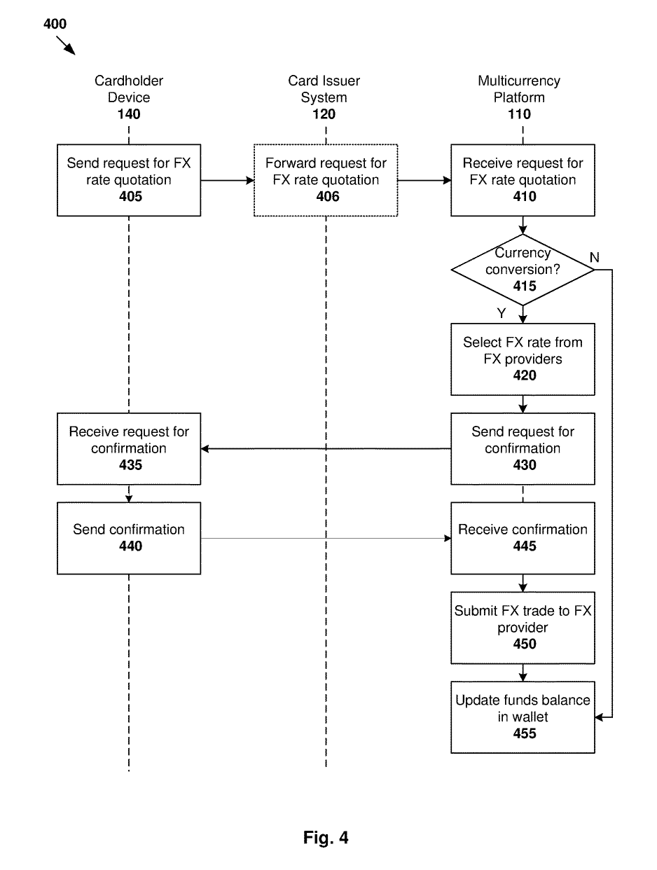

Multicurrency platform 110 performs data processing to support funds transfers to multicurrency card 200, or between wallets 240. Such funds transfers allow cardholder 160 to “lock in” particular exchange rates prior to using the multicurrency card 200 for a transaction. Besides providing FX rate certainty prior to a transaction date, cardholder 160 may initiate the funds transfer at any time they like, such as when an FX rate is particularly favourable. Further, if a particular wallet 240 is no longer in use, its account balance 244 may be transferred to another wallet 240. In the following, example funds transfers will be explained further using example user interfaces in FIG. 3A to 3F and example process 400 in FIG. 4.

Referring first to FIG. 3A to FIG. 3F, example user interfaces 310 to 360 are accessible via cardholder device 140, such as via a website or software application (see 142 in FIG. 1) operating on cardholder device 140. In FIG. 3A, example user interface 310 provides a summary of account balances 244 in all wallets 240. For example, local currency NZD wallet with NZD 1000 (see 312); AUD wallet with AUD 500; USD wallet with USD 100; EUR wallet with EUR 100 and JPY wallet with JPY 100. A “Manage Account” function (see 316) facilitates wallet management, such as for activating, deactivating or closing wallet 240, and configuring rule 246, etc. User interface 310 further includes an “Add Money” function (see 316) to transfer funds from an external source, and an “Exchange” function (see 318) to transfer existing funds from one wallet 240 to another.

In more detail, FIG. 3B illustrates example user interface 320 that facilitates funds transfer using the “Exchange” function (see 318) in FIG. 3A. The transfer is from source wallet 324 in a source currency (e.g., NZD wallet with NZD 1000) to a target or destination wallet 322 in a destination currency (e.g., AUD wallet with AUD 500). Source 342 and destination 344 wallets may be selected from the available wallets 240 (e.g., NZD, AUD, USD, EUR and JPY). A transfer amount may also be entered at 326, such as in the source currency (e.g., NZD) or destination currency (e.g., AUD). Although an example is shown, the transfer may be from any other suitable source (e.g., bank account, credit card, etc.).

Example user interface 320 further includes “Get Quote” function (see 327) to retrieve an FX rate quotation for the currency conversion. The “Get Quote” function may be used before or after the transfer amount is entered at 326. To select an FX rate, multicurrency platform 110 may perform example process 400 in FIG. 4. At blocks 405 and 410, multicurrency platform 110 receives a request for an FX rate quotation to transfer funds to a target wallet (e.g., AUD wallet) of multicurrency card 200. The request may be received directly from cardholder device 140 (as shown), or via card issuer system 120 (see box 406 in dotted lines).

At block 415 in FIG. 4, multicurrency platform 110 determines whether currency conversion is required to perform the funds transfer. Using the example in FIG. 3B, currency conversion is required because the source wallet (e.g., NZD wallet) and the target wallet (e.g., AUD wallet) are in different currencies.

At block 420 in FIG. 4, since currency conversion is required, multicurrency platform 110 selects an FX rate for the conversion. In one example, multicurrency platform 110 may retrieve (e.g., in real time) multiple candidate FX rates from multiple FX provider systems 150 via protocol handlers 118. Based on a comparison of the candidate FX rates, multicurrency platform 110 selects an FX rate that is the most favourable for the conversion. In the example in FIG. 3B, for the candidate FX rates of 0.90, 0.89 and 0.87, multicurrency platform 110 selects 0.90, i.e. the most favourable FX rate to cardholder 160.

In practice, the selected FX rate at block 420 may represent an “effective rate” that incorporates a fee associated with the currency conversion. The fee may be charged by one or more of: multicurrency platform 110, FX provider system 150 and card issuer system 120. In one example, the effective FX rate may be calculated as (1−M)×Actual FX rate. For example, if M=2% and Actual FX rate=0.918, the effective FX rate is (1−0.02)×0.918=0.90. M represents a mark-up percentage that may vary depending on any suitable factors, such as fees charged by various entities, such as multicurrency platform 110, FX provider system 150 and card issuer system 120, etc. When selecting the FX rate at block 420, multicurrency platform 110 considers the different values of M.

At block 430 in FIG. 4, multicurrency platform 110 sends a request to cardholder device 140 (directly or via card issuer system 120) to confirm the funds transfer at the selected FX rate. The confirmation request may be sent along with any relevant information, such as the selected FX rate (e.g., 0.90) and exchanged amount (e.g., AUD 90). Although not shown in FIG. 3B, other FX rates not selected by multicurrency platform 110 may also be sent to cardholder device 140.

At block 435 in FIG. 4, cardholder device 140 receives the request and displays relevant information for confirmation by cardholder 160. For example, as shown in FIG. 3B, the selected FX rate (see “NZD 1=AUD 0.90”) is presented at 328. Referring to example user interfaces 330 in FIG. 3C and 340 in FIG. 3D, cardholder 160 may then enter the amount to be transfer, such as NZD 100 which may be exchanged to AUD 90 at the selected FX rate.

At blocks 440 and 445 in FIG. 4, multicurrency platform 110 receives confirmation from cardholder device 140. For example, confirmation of the selected FX rate may be received via example user interface 350 in FIG. 3E. Data relating to the transfer is presented, such as the source amount (e.g., NZD 100), destination amount (e.g., AUD 90) and selected FX rate (e.g., NZD 1=AUD 0.90). In addition, at 352, a time period for which the selected FX rate is valid is also presented in FIG. 3E. For example, the time period may be 60 seconds and multicurrency platform 110 sets a timer that counts down from 60 seconds to zero (17 seconds shown). Confirmation of the funds transfer may be made by clicking on the “Confirm” button at 354 in FIG. 3E.

At blocks 450 and 455 in FIG. 4, multicurrency platform 110 completes the funds transfer from the source wallet (e.g., NZD wallet) to the destination wallet (e.g., AUD wallet) at the FX rate selected at block 420 (e.g., 0.90). This involves multicurrency platform 110 submitting an FX trade to FX provider system 150 that offers the selected FX rate to effect the currency conversion (see 450). Account balances 244 in the relevant wallets 240 may then be updated accordingly (see 455). For example, in FIG. 3F, example user interface 360 shows a summary of account balances 244 after the funds transfer. Compared to FIG. 3A, the account balance of the source wallet has decreased (e.g., from NZD 1000 to 900), and that of the destination wallet has increased (e.g., from AUD 500 to AUD 590), by the exchanged amount.

Although FIG. 3A to FIG. 3F illustrate an example funds transfer that requires currency conversion, it will be appreciated the source currency may be the same as the destination currency. In this case, example process 400 may process from block 415 to block 450 to complete the funds transfer and update account balance 244 of the destination wallet (without performing any currency conversion).

Further, although FIG. 3A to FIG. 3F illustrate an example funds transfer between wallets 240 associated with the same multicurrency card 200, it will be appreciated that funds may be transferred between wallets 240 of different multicurrency cards 200. In this case, the funds transfer may represent a Peer to Peer (P2P) remittance from a source multicurrency card 200 to a destination multicurrency card 200. Source wallet (see 324 in FIG. 3B) may be identified using card information of the source multicurrency card 200 and one of its wallets 240.

Card Processing by Multicurrency Platform

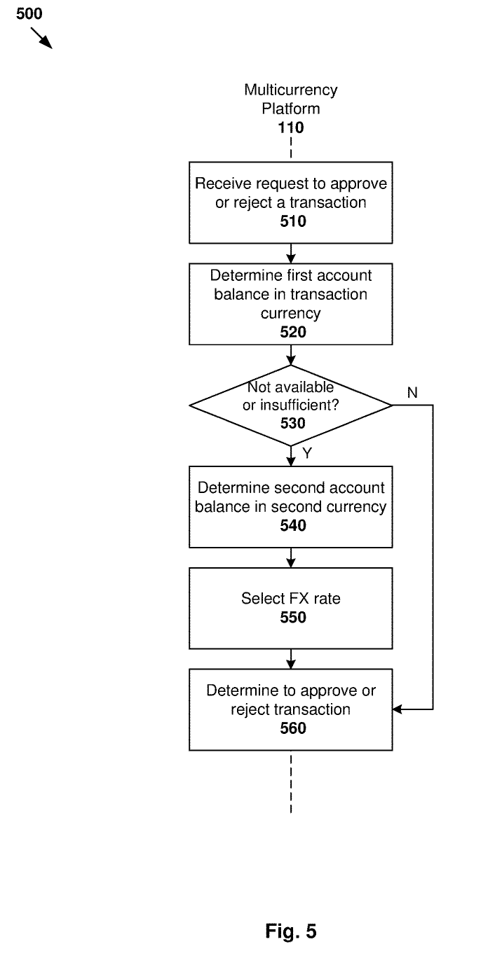

After funds are transferred, multicurrency card 200 may be used by cardholder 160 for a transaction with merchant system 130. In this case, multicurrency platform 110 may perform example process 500 in FIG. 5 to determine whether to approve or reject the transaction. The transaction may be associated with a transaction amount in a transaction currency that is supported or not supported by multicurrency card 200. If the transaction currency is not supported, or first account balance in the transaction currency is insufficient, multicurrency platform 110 may approve or reject the transaction based on a currency conversion of a second account balance in a different currency.

At block 510 in FIG. 5, multicurrency platform 110 receives a request to approve or reject a transaction using multicurrency card 200. The transaction is associated with a transaction amount in a transaction currency (e.g., AUD 600).

At block 520 in FIG. 5, multicurrency platform 110 determines, from multiple account balances 244 in multiple currencies 242 of multicurrency card, a “first account balance” 244 in the transaction currency (e.g., AUD 500 in AUD wallet 240-2) to fund the transaction amount (e.g., AUD 600).

At block 530 in FIG. 5, multicurrency platform 110 determines whether the first account balance 244 is not available or insufficient to fund the transaction amount. For example, account balance 244-2 (e.g., AUD 500 in AUD wallet 240-2) in FIG. 2 does not have sufficient balance to fund a transaction amount of AUD 600. In another example, a first account balance in Singaporean Dollar (SGD) is not available.

At block 540 in FIG. 5, if the first account balance 244 is not available or insufficient, multicurrency platform 110 determines a second account balance 244 from the multiple account balances. Second account balance 244 is in a second currency (e.g., NZD 1000 in NZD wallet 240-1) that is different to the transaction currency (e.g., AUD) to fund the transaction amount.

At block 550 in FIG. 5, multicurrency platform 110 selects an FX rate for dynamic currency conversion of the second account balance from the second currency (e.g., NZD) to the transaction currency (e.g., AUD). For example, similar to block 420 in FIG. 4, multicurrency platform 110 may retrieve multiple candidate FX rates from multiple FX provider systems 150 via protocol handlers 118. Based on a comparison of the retrieved FX rates, multicurrency platform 110 may select the FX rate that is the most favourable for the currency conversion. The selected FX rate may be an “effective rate” that incorporates various fees. For example, the candidate FX rates may be 0.90, 0.89 and 0.87 in which case 0.90 is selected at block 550.

The most favourable FX rate may be selected for the currency conversion based on candidate FX rates retrieved from multiple FX provider systems 150 either in real time when processing the transaction, or prior to receiving the request at block 510 (e.g., at predetermined intervals). In the latter case, the pre-retrieved candidate FX rates may be stored by multicurrency platform 110 in the form of a “rate card” that is accessible when currency conversion is required. Using FX rates retrieved at predetermined intervals generally reduces the traffic between multicurrency platform 110 and FX provider systems 150, but they generally result in a less accurate conversion especially in a volatile currency market.

At block 560 in FIG. 5, multicurrency platform 110 determines whether to approve or reject the transaction based on the currency conversion of part or all of the second account balance (e.g., NZD 1000) from the second currency to the transaction currency using the selected FX rate (e.g., NZD to AUD conversion using FX rate=0.90).

The determination of the first account balance at block 520 and second account balance at block 540 may be performed based on rules 246 associated with multicurrency card 200. For example, rules 246 may define an order according to which currency conversion may be iteratively performed on account balances 244 to fund the transaction amount.

In the examples according to the present disclosure, the term “dynamic currency conversion” may refer generally to an automatic process for currency conversion that may be performed without requiring any intervention by or input from cardholder 160. Using example process 500, multicurrency platform 110 facilitates transactions using both the first and second account balances 244 to fund the transaction when the first account balance is (A) insufficient or (B) not available for the transaction.

In scenario (A), cardholder 160 may rely not only on the first account balance in the transaction currency, but also the second account balance in a different currency. This still allows cardholder 160 to take advantage of the “locked in” FX rate used for pre-transaction funds transfer, without causing rejection of the transaction merely because the first account balance is insufficient.

In scenario (B), cardholder 160 may conduct the transaction even when the first account balance is not available, i.e. none of the account balances are in the transaction currency (e.g., SGD). As long as multicurrency card 200 has sufficient funds that may be converted to the transaction currency, cardholder 160 may still take advantage of existing funds transferred before the transaction. As such, the transaction will not be rejected by multicurrency platform 110 merely because there is no account balance in the transaction currency (e.g., SGD).

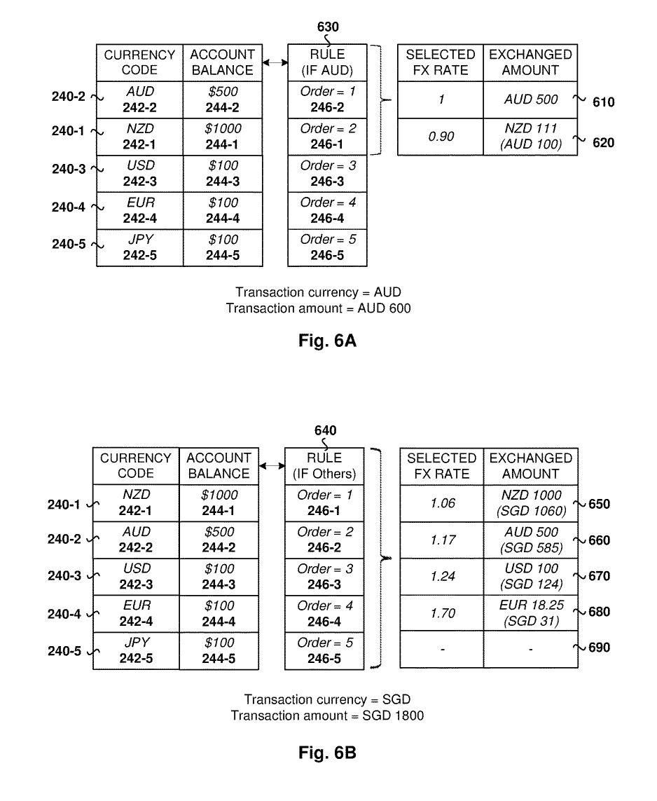

Example scenarios (A) and (B) will be explained with reference to FIG. 6A and FIG. 6B, with transaction amounts AUD 600 and SGD 1800, respectively. Referring first to FIG. 6A, multicurrency platform 110 may first use AUD account balance 244-2 (“first account balance”) in the transaction currency of AUD to fund the transaction according to block 520 in FIG. 2. In this case, account balance 244-2 of AUD 500 is insufficient to the whole transaction amount of AUD 600 (see also 610 in FIG. 6A).

As such, according to blocks 530 and 540 in FIG. 5, multicurrency platform 110 selects NZD account balance 244-1 (“second account balance”) of a different currency to fund the remaining transaction amount. According to block 550 in FIG. 5, multicurrency platform 110 may select an FX rate that is most favourable for the currency conversion from NZD (“second currency”) to AUD (“transaction currency”). In the example in FIG. 6A, the selected FX rate is 0.90, and currency conversion of NZD 111 may be performed to obtain an exchanged amount of AUD 100 (see 620 in FIG. 6A).

Since both AUD account balance 244-2 and NZD account balance 244-1 are sufficient to cover the transaction amount, multicurrency platform 110 approves the transaction according to block 560 in FIG. 5. After the transaction is approved, both AUD account balance 244-2 and NZD account balance 244-1 may be updated to AUD 0 (zero) and NZD 889 (i.e. 1000−111), respectively.

In the example in FIG. 6A, rules 246 define an order according to which various account balances 244 are analysed by multicurrency platform 110 to fund the transaction. For example, rules 246 in FIG. 6A are associated with the case of transaction currency=AUD. See 630, illustrating an order of (1) AUD, (2) NZD, (3) USD, (4) EUR and (5) JPY.

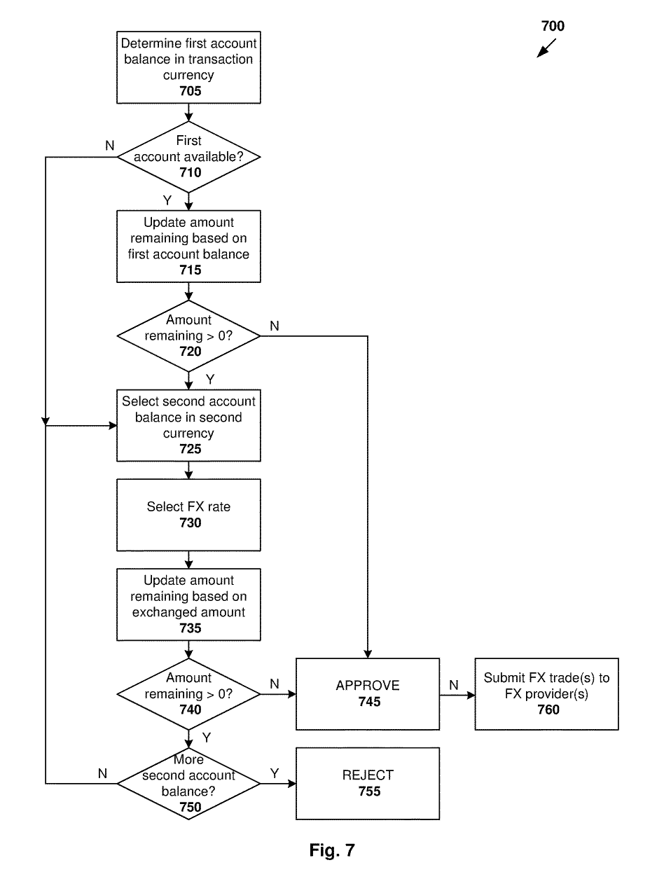

It should be understood that, for simplicity, example process 500 in FIG. 5 illustrates one “second account balance” at block 540 (e.g., in NZD). In practice, multiple “second account balances” may be used. For example, if NZD account balance 244-1 in FIG. 6A is insufficient to cover the transaction amount after currency conversion, blocks 540 and 550 in FIG. 5 may be repeated to iteratively consider other account balances (e.g., in USD, EUR and JPY) according to rules 246. An example of such iterative processing will be explained with reference to FIG. 6B and FIG. 7.

Iterative Processing

Referring now to FIG. 6B, the transaction currency of SGD is not one of the currencies 242 associated with multicurrency card 200. To determine whether to approve or reject the transaction, multicurrency platform 110 may retrieve rules 246 defining an order according to which various account balances 244 may be analysed by multicurrency platform 110 to fund the transaction amount. As indicated at 640 in FIG. 6B, rules 246 define an order of (1) NZD, (2) AUD, (3) USD, (4) EUR and (5) JPY.

Based on rules 246, multicurrency platform 110 may determine a “first account balance” (e.g., NZD), and multiple “second account balances” (e.g., AUD, USD and EUR) to fund the transaction amount. The example in FIG. 6B will also be explained with reference to FIG. 7, which shows an example iterative process 700 to determine the first and second account balances.

At block 705 in FIG. 7 (related to 520 in FIG. 5), multicurrency platform 110 determines a first account balance in the transaction currency (e.g., SGD) to fund the transaction amount (e.g., SGD 1800). In the example in FIG. 6B, account balances 246 may be analysed according to rules 246.

At block 710 in FIG. 7 (related to block 530 in FIG. 5), multicurrency platform 110 determines whether the first account balance is available. If yes, at blocks 715 and 720, multicurrency platform 110 calculates an amount remaining by deducting the transaction amount (e.g., SGD 1800) from the first account balance. In the example in FIG. 6B, there is no account balance in SGD, causing example process 700 to proceed to block 725.

At block 725 in FIG. 7 (related to block 540 in FIG. 5), multicurrency platform 110 determines a second account balance 244 in a second currency 242 to fund the transaction amount. For example in FIG. 6B, multicurrency platform 110 may iteratively analyse all account balances 244 according to rules 246, in which case NZD account balance 244-2 is first selected.

At block 730 in FIG. 7 (related to block 550 in FIG. 5), multicurrency platform 110 selects an FX rate for dynamic currency conversion. For example, multicurrency platform 110 may retrieve multiple candidate FX rates from FX provider systems 150 via protocol handlers 118 at FX engine 116. One FX rate is then selected from the candidate FX rates. Similar to block 550, the FX rate may be selected for currency conversion based on candidate FX rates retrieved from multiple FX provider systems 150 in real time when processing the transaction, or at predetermined intervals (e.g., daily) prior to processing the transaction.

In the example in FIG. 6B, the selected FX rate of 1.06 is used for conversion from the second currency (i.e. NZD) to the transaction currency (i.e. SGD). As previously mentioned, the selection may take into account fees charged by various parties and comparison of effective rates. Based on the FX rate, dynamic currency conversion of NZD 1000 to SGD at 1.06 obtains an exchanged amount of SGD 1060 (see 650 in FIG. 6B).

At block 735 in FIG. 7 (related to block 560 in FIG. 5), multicurrency platform 110 updates the amount remaining based on the second account balance. In the example in FIG. 6B, the amount remaining is SGD 740, i.e. transaction amount of SGD 1800 minus SGD 1060 (converted from NZD 1000).

At blocks 740, 745 and 750 (related to block 560 in FIG. 5), if the second account balance is insufficient (i.e. amount remaining>0), multicurrency platform 110 repeats blocks 725 to 735 to determine a further second account balance to fund the amount remaining (e.g., SGD 1800−1060=740).

At block 760, multicurrency platform 110 submits one or more FX trades to one or more FX provider systems 150 associated with the currency conversion to the transaction currency. Using the example in FIG. 6B, an FX trade is submitted to one or more FX provider systems 150 offering the selected FX rates of 1.06 (see 650), 1.17 (see 660), 1.24 (see 670) and 1.70 (see 680) via appropriate protocol handler(s) 118. The currency conversion is effected once the FX trade is processed.

In the example in FIG. 6B, multicurrency platform 110 analyses account balances 244 in the order of AUD, USD, EUR and JPY according to rules 640. As indicated at 660, AUD account balance 244-2 is used to fund the transaction based on conversion from AUD 500 to SGD 585 at a selected FX rate of 1.17 (see 660). Since there is still amount remaining (i.e. SGD 740−585>0), multicurrency platform 110 next analyses USD account balance 244-3 and EUR account balance 244-4.

Conversion of USD 100 at a selected FX rate of 1.24 obtains SGD 124 (see 670), while EUR 18.25 at 1.70 obtains SGD 31 (see 680). Since the amount remaining after conversion of EUR to SGD is zero (i.e. SGD 1800−1060−585−124−31=0), it is not necessary to consider account balance 244-5 in JPY wallet 240-5 (see 690). Example process 700 then reaches block 745 in FIG. 7 and the transaction is approved. As such, in the example in FIG. 6B, account balances 244-1 to 244-4 in NZD, AUD, USD and EUR may be referred to as “second account balances”.

It will be appreciated that, for each currency conversion in FIG. 7, the FX rate may be automatically selected by multicurrency platform 110 to be the most favourable to cardholder 160. Also, although FIGS. 6A and 6B illustrate example transactions that are approved, multicurrency platform 110 may reject a transaction if the “second account balances” have insufficient funds according to blocks 750 and 755.

Communication with Multicurrency Platform 110

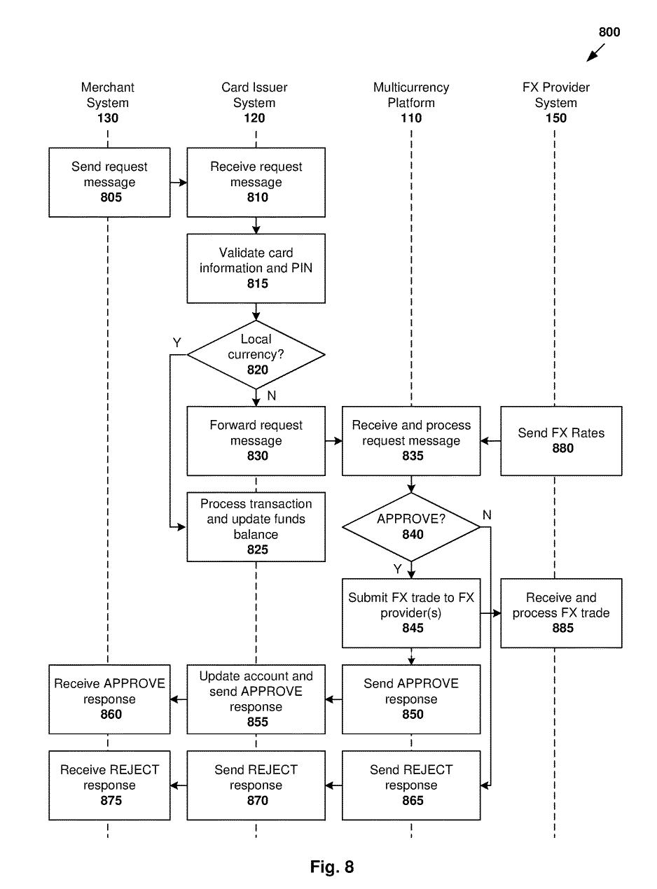

FIG. 8 (related to block 510 in FIG. 5) is a flowchart of example process 800 by multicurrency platform 110 for communicating with card issuer system 120, merchant system 130 and FX provider system 150 during a transaction.

At block 805 in FIG. 8, merchant system 130 sends a request message to card issuer system 120 to approve or reject a transaction between cardholder 160 and merchant system 130. The currency for the transaction may be referred to as transaction currency (e.g., AUD in FIG. 6A), and its amount as transaction amount (e.g., AUD 600 in FIG. 6A). The terms “authorisation currency” and “authorisation amount” may also be used to describe the transaction currency and amount, respectively.

The “request message” may be a message in any suitable format and include information that allows card issuer system 120 and multicurrency platform 110 to identify multicurrency card 200 and retrieve its information, such as card number 210 and expiration date, etc. The request message may further include information of the transaction (e.g., transaction amount), and any relevant security information (e.g., personal identification number (PIN) associated with multicurrency card 200). The request message may be generated by a POS device (if the transaction is conducted at a physical premise of the merchant) or a server computer of merchant system 130 (for online purchase).

At blocks 810 and 815 in FIG. 8, card issuer system 120 receives the request message and performs any necessary initial processing, such as validation of card information and PIN (if any). At block 820 in FIG. 8, card issuer system 120 determines whether the transaction currency (e.g., AUD) is the same as the local currency (e.g., NZD) of multicurrency card 200. At block 825, if yes, card issuer system 120 may process the transaction and update account balance 244 of wallet 240 associated with the local currency. Otherwise (i.e. different currencies), at block 830, card issuer system 120 forwards the request message to multicurrency platform 110 for further processing.

At block 835 in FIG. 8, multicurrency platform 110 receives and processes the request message according to examples in FIG. 5 to FIG. 7. At block 840, multicurrency platform 110 determines whether to approve or reject the transaction. If yes (i.e. sufficient funds), multicurrency platform 110 submits an FX trade to each relevant FX provider at block 845, and replies with an “APPROVE” response to merchant system 130 via card issuer system 120 at blocks 850, 855 and 860. Otherwise, at blocks 865, 870 and 875, a “REJECT” response will be sent.

Further, as indicated at block 880 in FIG. 8, multicurrency platform 110 retrieves FX rates from multiple FX provider systems 150 (one shown for simplicity). The FX rates may be received via protocol handlers 118 at FX engine 116 using either a push or pull model. In particular, FX engine 116 may explicitly request for the FX rates from multiple FX provider systems 150 (pull model), or multiple FX provider systems 150 may send the FX rates to FX engine 116 via an established connection (push model). To reduce traffic, the FX rates may be received periodically. At block 885, FX provider system 150 also processes an FX trade received from multicurrency platform 110 to effect the currency conversion.

Object-Oriented Programming (OOP) Framework

Multicurrency platform 110 may be implemented using any suitable software, hardware or a combination of both. In one example shown in FIG. 9, multicurrency platform 110 may be implemented using an OOP framework. Example class diagram. 900 illustrates a high level implementation of multicurrency platform 110 based on the OOP framework. Functions relating to such data processing may be accessed by card issuer system 120 and/or merchant system 130 using any suitable approach, such as application programming calls (APIs), etc.

At 910 in FIG. 9, platform interface 112 may be implemented using a class with any suitable functions relating to:
(1) Funds transfer, e.g., transfer( )
(2) Balance query, e.g., getAvailBalance( ) getPostedBalance( )
(3) Wallet management including activation, deactivation, opening and closing, e.g., getAccountForCurrency( ), addPurseAccount( ), activatePurse( ) and closePurse( )
(4) Rules 246, e.g., getDrawdownOrder( ) and setDrawdownOrder( )
(5) Transaction query, e.g., getTransactions( )
(6) Authorisation, e.g., getOpenAuthorizations( ) to retrieve transactions that have not been settled and are under authorisation holds; and
(7) Access to functions supported by FX evaluator 114 (e.g., getFxEvaluator( ) to obtain an instance of FX evaluator) and FX engine 116 (e.g., getExchangeRates( ) for FX rates retrieval).

At 920 in FIG. 9, FX evaluator 114 may be implemented using a class with any suitable functions to determine “first account balance” and “second account balance(s)” according to FIG. 5 and FIG. 7. In the example in FIG. 9, function applyDebit( ) may be used to compute “what-if” scenarios, such as when multicurrency platform 110 needs to debit an amount from one wallet (e.g., NZD wallet 240-1) that does not have sufficient funds. In this case, FX evaluator 114 may assess other account balances 244 and compute the amount needed to be transferred from other wallets 240 to fulfil the request based on FX rates obtained from FX provider systems 150.

At 930 in FIG. 9, FX engine 116 may be implemented using a class with any suitable functions to support funds transfers between two wallets 240, e.g., prepareOrder( ) and submitOrder( ).

At 940 in FIG. 9, protocol handler 118 may be implemented using a class with any suitable functions relating to FX rates retrieval (e.g., getExchangeRate( ), getAllExchangeRates( ), getExchangeRates( ), verifyFxRate( )). Class 940 may further include other methods relating to authorization (e.g., authorization( ); release (e.g., releaseauthorization( )) and transfers (e.g., transfer( ), transferReversal( ), cancelTransfer( ), completeTransfer( )), etc. Different protocol handlers 118-1 to 118-3 may be implemented using class 940 as a base class.

At 950 in FIG. 9, a class representing wallet 240 is also shown. For example, to gain access to functions supported by platform interface 112, an instance of class 950 may be created and used to, for example, query the status and account balance 244 of wallet 240. See examples in FIGS. 3A-3B and FIG. 4 again.

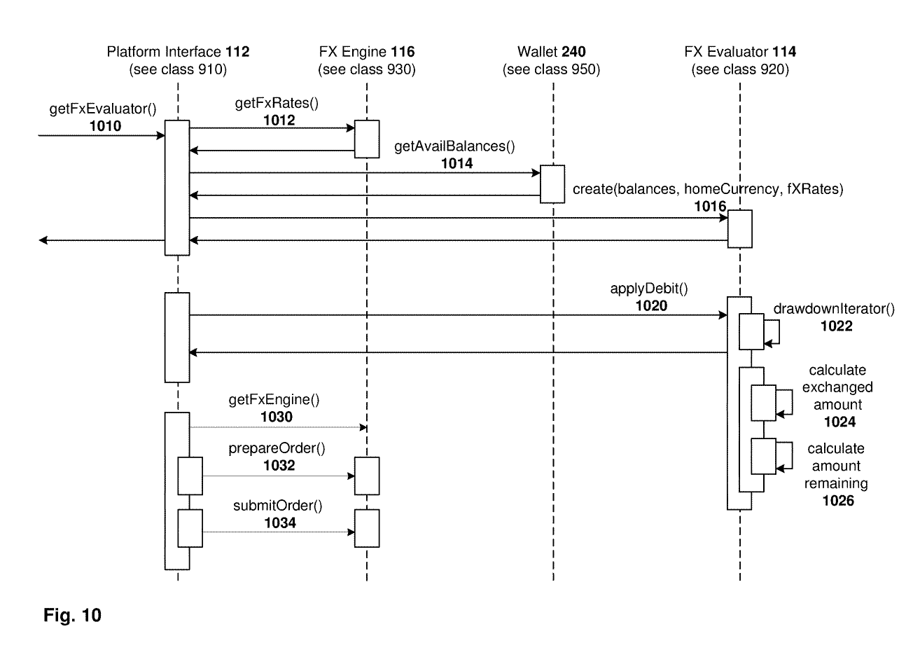

FIG. 10 is a schematic diagram of example function calls using example classes in FIG. 9. For example, at 1010 in FIG. 10, to fund a transaction amount from wallets 240, a caller program at multicurrency platform 110 or any other suitable software source may first retrieve an instance of FX evaluator 114 to calculate impact of the transaction amount on the wallets 240. When the instance is created, it obtains current FX rates using getFxRates( ) at 1012 and available balances of wallets 240 using getAvailBalances( ) at 1014. Then, at 1016, the instance may be created by calling create(balances, homeCurrency, fXRates) where “balances” represents account balances 244, “homeCurrency” represents a local currency, and “fXRates” represents retrieved FX rates.

To determine whether to approve or reject a transaction, applyDebit( ) function may be called at 1020 in FIG. 10. At 1022, “drawdowniterator” retrieves rules 246 (e.g., order) to analyse account balances 244 of multicurrency card. At 1024 and 1026, a first account balance and/or at least one second account balance 244 may be selected until the amount remaining is zero (e.g., see blocks 725 to 750 in FIG. 7 again). If the transaction is approved, the result of applyDebit( ) may include a list of account balances 244 to fund the transaction amount.

To perform funds transfers, an instance of FX Engine 116 may be obtain at 1030 in FIG. 10. To transfer funds between wallets 240, prepareOrder( ) and submitOrder( ) may be called at 1032 and 1034, respectively. Function prepareOrder( ) may be used to retrieve FX rates and selects the most favourable FX rate according to block 550 in FIG. 5. In particular, prepareOrder( ) may include computation of any fees (e.g., fee for sender, markup fee, fee for receiver, etc.) to compare effective FX rates. To complete the order, function submitOrder( ) may be called to create any necessary transactional entries based on the order. FX engine 116 then submits the order to an appropriate protocol handler 118 to complete the FX trade with FX provider system 150.

Although not shown in FIG. 10, other function calls relating to authorization and clearing may be made. In general, multicurrency platform 110 receives an authorization request when multicurrency card 200 is used, and a clearing message from a payment network switch some time later. For certain transactions and/or payment network switch (e.g., multilayer director switch (MDS)), authorisation may not be necessary in which case multicurrency platform 110 receives a request message in the form of a real-time purchase request. In this case, an authorization hold may be placed on wallets 240 (e.g., using getOpenAuthorization( )) such that funds are not transferred.

Further, for clearing purposes, multicurrency platform 110 may first release corresponding authorisation holds on wallets 240. For example, getFxEvaluator( ) may be called to analyse various account balances 244 to fund a transaction amount. For each transfer amount, the function transfer( ) may be called to transfer funds between wallets 240.

Computer System

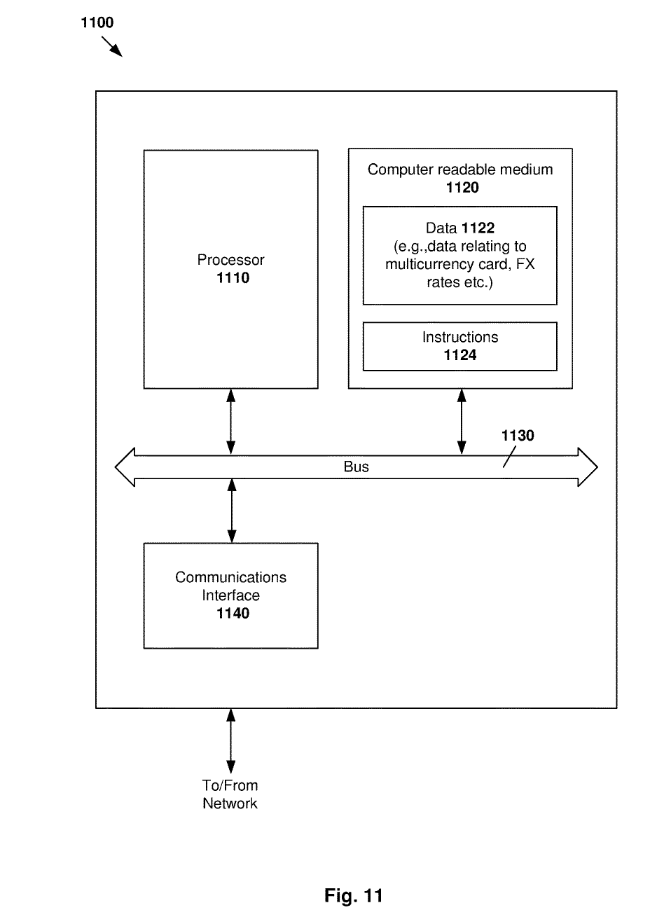

FIG. 11 is a schematic diagram of example computer system 1100 capable of implementing multicurrency platform 110 (“card processing system”) in FIG. 1. Example computer system 1100 may include processor 1110, computer-readable storage medium 1120, communications interface 1140, and communications bus 1130 that facilitates communication among these illustrated components and other components.

Processor 1110 is to perform processes described herein with reference to FIG. 1 to FIG. 10. Computer-readable storage medium 1120 may store any suitable data 1122, such as data relating to multicurrency card 200, FX rates, etc. Non-transitory computer-readable storage medium 1120 may further store instructions set 1124 that, when executed by processor 1110, cause processor 1110 to perform processes described herein with reference to FIG. 1 to FIG. 10.

The techniques introduced above can be implemented in special-purpose hardwired circuitry, in software and/or firmware in conjunction with programmable circuitry, or in a combination thereof. Special-purpose hardwired circuitry may be in the form of, for example, one or more application-specific integrated circuits (ASICs), programmable logic devices (PLDs), field-programmable gate arrays (FPGAs), and others. The term ‘processor’ is to be interpreted broadly to include a processing unit, ASIC, logic unit, or programmable gate array etc.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof.

Those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure.

Software and/or firmware to implement the techniques introduced here may be stored on a non-transitory computer-readable storage medium and may be executed by one or more general-purpose or special-purpose programmable microprocessors. A “computer-readable storage medium”, as the term is used herein, includes any mechanism that provides (i.e., stores and/or transmits) information in a form accessible by a machine (e.g., a computer, network device, personal digital assistant (PDA), mobile device, manufacturing tool, any device with a set of one or more processors, etc.). For example, a computer-readable storage medium includes recordable/non recordable media (e.g., read-only memory (ROM), random access memory (RAM), magnetic disk storage media, optical storage media, flash memory devices, etc.).

The drawings are only illustrations of an example, wherein the units or procedure shown in the drawings are not necessarily essential for implementing the present disclosure. Those skilled in the art will understand that the units in the device in the examples can be arranged in the device in the examples as described, or can be alternatively located in one or more devices different from that in the examples. The units in the examples described can be combined into one module or further divided into a plurality of sub-units.

As used herein, the terms “including” and “comprising” are used in an open-ended fashion, and thus should be interpreted to mean “including, but not limited to . . . .” It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A card processing method implemented by a card processing system, comprising:
receiving a request to approve or reject a transaction using a multicurrency card with multiple account balances in multiple currencies, wherein the transaction is associated with a transaction amount in a transaction currency;
determining, from the multiple account balances, a first account balance in a first currency that is the same as the transaction currency to fund the transaction amount;
in response to determination that the first account balance is not available or insufficient to fund the transaction amount,
determining, from the multiple account balances, a second account balance in a second currency that is different to the transaction account to fund the transaction amount;
selecting an exchange rate for dynamic currency conversion of part or all of the second account balance from the second currency to the transaction currency; and
determining whether to approve or reject the transaction based on the dynamic currency conversion using the selected exchange rate.

2. The method of claim 1, wherein selecting the exchange rate comprises:
retrieving, in real time from multiple foreign exchange provider systems, multiple candidate exchange rates to convert the second currency to the transaction currency; and
selecting the exchange rate from the multiple candidate exchange rates that is the most favourable for the dynamic currency conversion.

3. The method of claim 2, wherein the exchange rate selected from the multiple candidate exchange rates is an effective exchange rate determined based on a fee associated with the dynamic currency conversion.

4. The method of claim 1, 2 or 3, wherein the card processing system comprises at least one of:
an interface to receive, from a card issuer system or a merchant system, the request to approve or reject the transaction;
a foreign exchange evaluator to determine the first account balance and the second account balance to fund the transaction amount; and
a foreign exchange engine to retrieve the exchange rate from a foreign exchange provider system.

5. The method of claim 4, wherein the foreign exchange engine implements an abstraction layer at the card processing system to communicate with multiple foreign exchange provider systems using multiple communication protocols and to retrieve multiple candidate exchange rates from which the exchange rate is selected.

6. The method of any one of the preceding claims, wherein determining the second account balance in the second currency further comprises:
retrieving a rule associated with the dynamic currency conversion of the second account balance; and
selecting the second account balance from the multiple account balances based on the rule.

7. The method of claim 6, wherein the retrieved rule defines an order according to which dynamic currency conversion is iteratively performed on the multiple account balances until the transaction amount is fully funded.

8. The method of any one of the preceding claims, wherein determining whether to approve or reject the transaction further comprises:
in response to determination that dynamic currency conversion of part or all of the second account balance is insufficient to fund the transaction amount,
determining at least one further second account balance in a further second currency to fund the transaction amount; and
retrieving a further exchange rate for dynamic currency conversion of the further second currency to the transaction currency to fund a remaining transaction amount.

9. The method of any one of the preceding claims, wherein determining to approve or reject the transaction further comprises:
in response to determination that the first account balance is available but insufficient to fund the transaction amount,
determining a sum of the first account balance and the second account balance in the transaction currency after dynamic currency conversion; and
determining to approve the transaction if the sum is sufficient to fund the transaction amount.

10. The method of any one of the preceding claims, further comprising prior to the transaction:
receiving a request to transfer an amount from a source account balance in a source currency to a destination account balance in a destination currency, wherein the source account balance and destination account balance are associated with the multicurrency card;
retrieving an exchange rate for currency conversion from the source currency to the destination currency; and
based on the amount to be transferred and the exchange rate, updating the source account balance and destination account balance.

11. The method of any one of the preceding claims, wherein the multicurrency card is a debit card, credit card or prepaid card with a card number associated with the multiple account balances in multiple currencies.

12. A computer system capable of acting as a card processing system, wherein the computer system comprises:
a processor; and
a non-transitory computer-readable medium having stored thereon instructions that, when executed by the processor, cause the processor to:
receive a request to approve or reject a transaction using a multicurrency card with multiple account balances in multiple currencies, wherein the transaction is associated with a transaction amount in a transaction currency;
determine, from the multiple account balances, a first account balance in a first currency that is the same as the transaction currency to fund the transaction amount;
in response to determination that the first account balance is not available or insufficient to fund the transaction amount,
determine, from the multiple account balances, a second account balance in a second currency that is different to the transaction account to fund the transaction amount;
select an exchange rate for dynamic currency conversion of part or all of the second account balance from the second currency to the transaction currency; and
determine whether to approve or reject the transaction based on the dynamic currency conversion using the selected exchange rate.

13. The computer system of claim 12, wherein when selecting the exchange rate, the processor is to:
retrieve, in real time from multiple foreign exchange provider systems, multiple candidate exchange rates to convert the second currency to the transaction currency; and
select the exchange rate from the multiple candidate exchange rates that is most favourable for the dynamic currency conversion.

14. The computer system of claim 13, wherein the exchange rate selected from the multiple candidate exchange rates is an effective exchange rate determined based on a fee associated with the dynamic currency conversion.

15. The computer system of claim 12, 13 or 14, wherein the processor is further to implement at least one of:
an interface to receive, from a card issuer system or a merchant system, the request to approve or reject the transaction;
a foreign exchange evaluator to determine the first account balance and the second account balance to fund the transaction amount; and
a foreign exchange engine to retrieve the exchange rate from a foreign exchange provider system.

16. The computer system of claim 15, wherein the foreign exchange engine implements an abstraction layer to communicate with multiple foreign exchange provider systems using multiple communication protocols and to retrieve multiple candidate exchange rates from which the exchange rate is selected.

17. The computer system of any one of claims 12 to 16, wherein when determining the second account balance in the second currency, the processor is further to:
retrieve a rule associated with the dynamic currency conversion of the second account balance; and
determine the second account balance by selecting the second account balance from the multiple account balances based on the rule.

18. The computer system of claim 17, wherein the retrieved rule defines an order according to which dynamic currency conversion is iteratively performed on the multiple account balances until the transaction amount is fully funded.

19. The computer system of any one of claims 12 to 18, wherein when determining whether to approve or reject the transaction, the processor is further to:
in response to determination that dynamic currency conversion of part or all of the second account balance is insufficient to fund the transaction amount,
determine at least one further second account balance in a further second currency to fund the transaction amount;
retrieve a further exchange rate for dynamic currency conversion of the further second currency to the transaction currency to fund a remaining transaction amount.

20. The computer system of any one of claims 12 to 19, wherein, prior to the transaction, the processor is further to:
receive a request to transfer an amount from a source account balance in a source currency to a destination account balance in a destination currency, wherein the source account balance and destination account balance are associated with the multicurrency card;
retrieve an exchange rate for currency conversion from the source currency to the destination currency; and
based on the amount to be transferred and the exchange rate, update the source account balance and destination account balance.

21. A card processing method implemented by a card processing system, comprising:
receiving a request to approve or reject a transaction using a multicurrency card with multiple account balances in multiple currencies, wherein the multicurrency card is a debit card or credit card, and the transaction is associated with a transaction amount in a transaction currency;
determining, from the multiple account balances, a first account balance in a first currency that is the same as the transaction currency to fund the transaction amount;
in response to determination that the first account balance is not available or insufficient to fund the transaction amount,
determining, from the multiple account balances, a second account balance in a second currency that is different to the transaction currency to fund the transaction amount;
retrieving an exchange rate for currency conversion of part or all of the second account balance from the second currency to the transaction currency, wherein the exchange rate is retrieved from one or more foreign exchange provider systems either in real time or prior to receiving the request; and
determining whether to approve or reject the transaction based on the currency conversion using the exchange rate.

22. A computer system capable of acting as a card processing system, wherein the computer system comprises:
a processor; and
a non-transitory computer-readable medium having stored thereon instructions that, when executed by the processor, cause the processor to:
receive a request to approve or reject a transaction using a multicurrency card with multiple account balances in multiple currencies, wherein the multicurrency card is a debit card or credit card, and the transaction is associated with a transaction amount in a transaction currency;
determine, from the multiple account balances, a first account balance in a first currency that is the same as the transaction currency to fund the transaction amount;
in response to determination that the first account balance is not available or insufficient to fund the transaction amount,
determine, from the multiple account balances, a second account balance in a second currency to fund the transaction amount, wherein the second currency is different to the transaction currency;
retrieve an exchange rate for currency conversion of part or all of the second account balance from the second currency to the transaction currency, wherein the exchange rate is retrieved from one or more foreign exchange provider systems either in real time or prior to receiving the request; and
determine whether to approve or reject the transaction based on the currency conversion using the exchange rate.
